(19) United States
(12) Patent Application Publication
(10) Pub. No.: US 2003/0067157 A1
(43) Pub. Date: Apr. 10, 2003

(54) Printed article with enhanced three-dimensional effect and related method of manufacture

(76) Inventor: Barron G. McKillip, La Verne, CA (US)

Correspondence Address: Allen W. Groenke, Fredrikson & Byron, P. A., 900 Second Avenue South, 1100 International Centre, Minneapolis, MN, 55402, US

(21) Appl. No.: 09/972,061

(22) Filed: Oct. 5, 2001

(51) Int. Cl. B42D 15/00

(52) U.S. Cl. 283/62

(57) ABSTRACT

Printed graphics for packaging, labels or signs including an etched or embossed appearance enhanced with a three-dimensional effect. The graphic includes a transparent substrate, a first extraordinarily thick ridge of ink deposited to form an image on one side of the substrate and a second extraordinarily thick ridge of ink deposited on the other side of the substrate. The two extraordinarily thick ridges preferably are in registration with one another to provide a three-dimensional appearance of the design. For an embossed appearance, the ridges of ink are uniformly smooth. For an etched appearance, the ridges of ink are formed with a textured pattern. A layer of reflective material may be sprayed, electroplated or vacuum metallized onto the substrate over the first thick ridge of ink to further enhance the appearance of the design. Alternatively, a label stock may be pressed onto the substrate over the first ridge of ink on the substrate. Optionally, a protective coating may be deposited over the second ridge of ink and the transparent substrate.

### BACKGROUND

The present invention relates to printed graphics and, more particularly, to packaging and promotional materials including an etched or embossed appearance.

Many manufacturers include complex, colorful, multi-printed graphics on product packaging, labels or displays to distinguish their products over competitor's products. Two common techniques that provide such complex graphics on product packaging are etching and embossing. Etching is a technique where a transparent substrate, for example glass, is scratched or corroded with an acid in select areas of the substrate to create a special esthetic effect. Embossing is a technique where a selected portion of surface of a sheet of packaging, labels or displays are raised or bulged to represent relief in those areas.

Although etching and embossing provide distinctive packaging, not until recently have the visual effects of both been successfully combined, due to the essentially incompatible nature of the two processes. A sign incorporating both etched glass and an embossed sheet appearance is disclosed in U.S. Pat. No. 5,082,703 to Longobardi, issued Jan. 21, 1992. Longobardi's sign includes an extraordinarily thick ridge of ink deposited on one side of a transparent substrate to outline an intended design. The ink ridge may be either uniformly smooth or textured to create a desired effect embossed or etched appearance, respectively.

Embossed and etched signs of the type described in Longobardi have become highly popular; however, their appeal is limited because their appearance is primarily two-dimensional. Significant opportunity exists for success with any new packaging or display that provides distinctive visual effects in addition to an embossed and etched appearance.

### SUMMARY OF THE INVENTION

The aforementioned problem is overcome in the present invention wherein packaging, labels and/or displays include a transparent substrate having extraordinarily thick ridges of ink printed on both sides of the substrate to provide a three-dimensional effect.

In the preferred embodiment, a first extraordinarily thick ridge or layer of ink is deposited on a first side of the substrate, for example a transparent plastic film, to establish an embossed or etched outline of an intended design. A second extraordinarily thick ridge or layer of ink is deposited on the other side of the substrate to provide a three-dimensional effect for the first embossing or etching ink. Depending on the positioning and registration of the second ink ridge with respect to the first ink ridge, the resultant packaging, label or display includes a three-dimensional or stereoscopic appearance to dramatically increase its consumer appeal.

In another embodiment, a relatively thin layer of tinted ink is deposited on one side of the transparent substrate to form a desired design. A first extraordinarily thick ridge of ink is deposited to overlap the edge of the design. On the other side of the transparent substrate, a second extraordinarily thick ridge of ink is deposited in registration with the edge of the design to create a three-dimensional effect. Optionally, the extraordinarily thick ridges of ink may be covered or coated with a protective layer of plastic or other material.

The present invention adds a novel three-dimensional effect to embossed or etched features of a design on packaging, labels or displays. The added visual effect enhances the esthetic appeal of products and distinguish those products from others bearing less eye-catching graphics.

These and other objects, advantages and features of the invention will be more readily understood and appreciated by reference to the detailed description of the preferred embodiments and the drawings.

### BRIEF DESCRIPTION OF THE DRAWINGS

FIG. 1 shows a top view of a preferred embodiment of the display of the present invention;

FIG. 2 is a sectional view of the display taken along line 2-2 of FIG. 1;

FIG. 3 is a front elevation view of a top of an ink ridge;

FIG. 4 is a front elevation view of a top of an alternative embodiment of the ink ridge;

FIG. 5 is a sectional view of the display taken along line 5-5 of FIG. 1;

FIG. 6 is a sectional view of a first alternative embodiment of the display taken along line 2-2 of FIG. 1;

FIG. 7 is a sectional view of a second alternative embodiment of the display taken along line 2-2 of FIG. 1; and

FIG. 8 is a sectional view of a third alternative embodiment of the display taken along line 2-2 of FIG. 1.

### DETAILED DESCRIPTION OF THE PREFERRED EMBODIMENTS

I. Construction of the Display

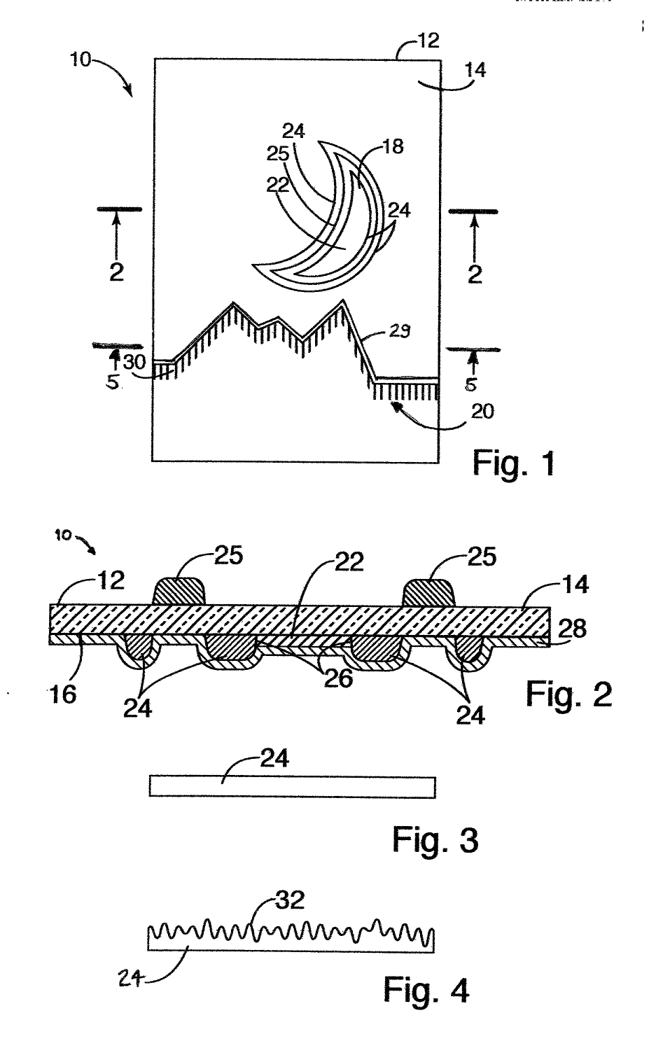

A display in accordance with the preferred embodiment of the present invention is shown in FIG. 1 and generally designated 10. As used herein, “display” also referred to as a “graphic,” includes any printed material, but is not limited to, packaging, labels, displays, boxes, trading cards, book covers, shrink sleeves, container wraps, tamper-proof closures, signs, posters, notebooks and puzzles. As shown in FIG. 1, the display 10 generally includes substrate 12, moon design 18 and mountain design 20. The substrate 12 includes top surface 14, which forms the front of display 10 and may be clear or color-tinted.

FIG. 2 shows a bottom surface 16, opposite the top surface 14 of substrate 12. As will be appreciated, the designs or images placed on the top surface 14 and bottom surface 16 may be of any shape or form as desired and may be text characters on graphic images. As used herein, “image” means any design, picture, graphic, or text. The substrate 14 is preferably clear or transparent, but it may be tinted and/or translucent as desired. As used herein, “transparent” means clear, transparent, or translucent and any combination thereof. With reference to FIGS. 1 and 2, moon design 18 is formed by the relatively thin ink layer 22 disposed on the bottom surface 16 of substrate 12 and an extraordinarily thick ridge of ink 24 deposited on bottom surface 16 and overlapping edge 26 of ink layer 22. Another extraordinarily thick ridge of ink 25 is deposited on surface 14 to add three-dimensional effect to the thin ink layer and thick ink ridge 24 on the bottom surface 16. Preferably, the top thick ink ridge 25 is in registration with at least one of the bottom thick ink ridges 24 and the thin ink layer 22. This makes the edges of the design 18 appear to be more three-dimensional in depth. Optionally, the moon design 18 may include only one ridge instead of the set of ridges 24. As will be appreciated, the ridge 25 may be positioned in any registration with respect to one or more ridges 24 on the bottom surface 16.

Preferably, the inks used for thick ridges 24 and 26 and thin ink layer 22 are liquid or semi-liquid materials suitable for producing designs as described herein. The inks may be relatively viscous and curable within a relatively short period of time, preferably less than about 60 seconds, more preferably about 2 to about 12 seconds, most preferably about 6 seconds. As used herein inks may also include commercially available varnishes. The different thick ink ridges 24 and 26 and thin ink layer 22 may be transparent, tinted, or opaque. For example, the ink layer 22 of design 18 may be colored, ink ridges 24 may be tinted and ink ridges 25 may be transparent or clear. The inks also may be printed on the substrate using any commercially available printing method, including conventional flexography, gravure, ultraviolet flexography and offset printing. The display may also be printed using web- and sheet-fed techniques as desired. The actual composition of the ink is preferably relatively viscous, that is, similar to the viscosity of enamel, epoxy and acrylic inks.

The ridges 24 and 25 of the present invention are exceptionally or extraordinarily thick. Preferably, the ink ridges 24 and 25 are greater than approximately one one-hundredths (0.01) of an inch, more preferably greater than one one-thousandths (0.001) of an inch in thickness. The ink ridges 24 and 25 may also be of thickness of less than one and one-quarter one-thousandths of an inch (0.00125) and most preferably between about one one-thousandths of an inch (0.001) and one and one-quarter one thousandths of an inch (0.00125). The thickness of the ink ridges may also be varied depending on the width of the ink ridge. For example, wider ink ridges may be of a greater thickness than more narrow ink ridges. Optionally, the thickness may be varied throughout the ridges depending on the desired visibility of the resultant visual effect. For example, with reference to FIG. 3, an ink ridge 24 is formed as uniform and smooth. In FIG. 1, this configuration creates an embossed appearance around the edges of the moon design 18. The cumulative effect of ridges 24 and 25 being smooth and uniform gives the appearance that the edge 26 of the ink layer 22 is beveled or raised and adds a three-dimensional effect, giving depth to the moon design 18.

With reference to FIG. 4, to obtain a different esthetic effect, ink ridge 24 and 25 may be formed with textured pattern 32, which gives the appearance that the surface 16 of the substrate 12 (FIG. 1) is etched and further includes a three-dimensional aspect. Optionally, the pattern 32 may be substituted with alternative patterns as desired to give various effects.

The display 10 may further include a sheet 28 disposed over bottom surface 16 so that the ink ridges 24 and ink layer 26 are sandwiched between the sheet 28 and surface 16. The sheet 28 may be constructed of any commercially available material such as paper, plastic or metal foil. Preferably, the surface of sheet 28 adjacent the bottom surface 16 includes a pressure sensitive or other commercially available adhesive that is transparent to adhere the sheet 28 to the bottom surface 16. Moreover, it is desired that the sheet 28 be sufficiently pliant to conform the contours created by the ink ridges 24. The sheet 28 may be applied to the bottom surface 16 using any conventional method. For example, a roller (not shown) may be used to press sheet 28 against the substrate to fill in crevices created on the surface 16 by the ink layer 22 and ink ridges 24. Optionally, the sheet 28 may be a silver, chrome or metallic ink coating or covering that is applied to the bottom surface 16 of the substrate 12. Alternatively, sheet 28 may be vacuum pressed onto the bottom surface 16 over ridges 24 and layer 22.

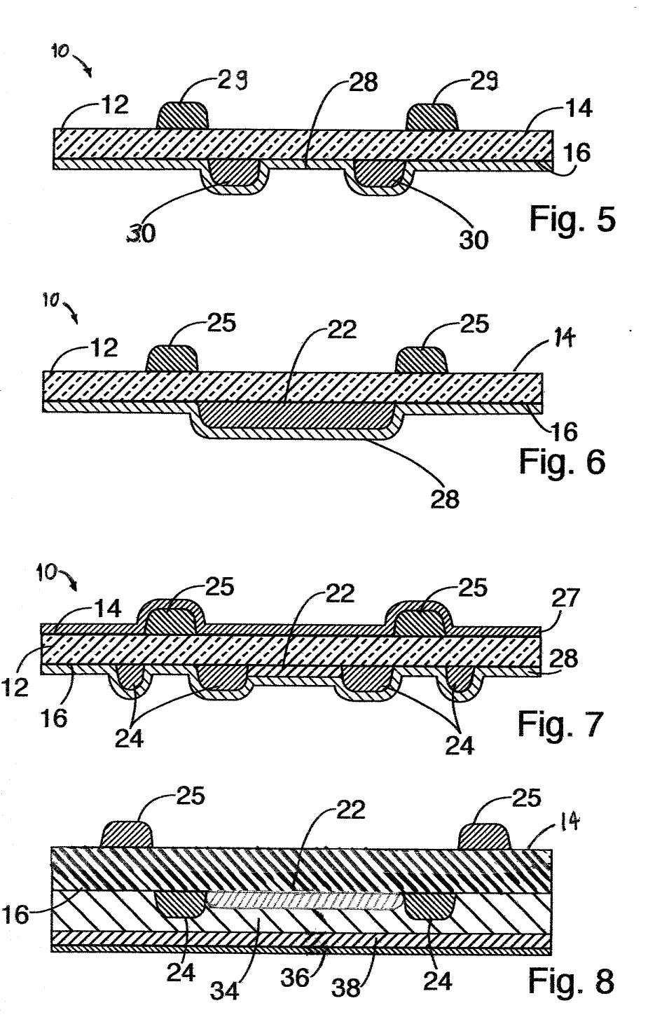

FIG. 5 shows a cross-section of the mountain design 20 of FIG. 1. In this construction, the thin ink layer is not present. Thus, the design 20 is formed by outlining the desired design configuration, here, the mountains 20 with thick ink ridge layer 30 on the bottom surface 16 of substrate 12. As a result, any color given to design 20 will either be from the sheet 28 or from a tint included in substrate 12. The thick ridge layer 29 on the top surface 14 of the substrate adds a three-dimensional effect to the display as desired.

II. Method of Manufacture

With reference to FIGS. 1-5, a preferred method of manufacturing the display 10 of the present invention will now be described.

First, an extraordinarily thick ridge or layer of viscous ink 24 is deposited on the surface 16 of the transparent substrate 12 in the shape of the desired design. Preferably, the thick ridge or layer of viscous ink is ultraviolet curable, but as noted above, may be any type of commercially available ink. With reference to FIGS. 3 and 4, if it is desired to establish a design including an embossed appearance, then the ridges 24 or ink layer deposited on the surface 16 should be uniformly smooth. If it is desired to give an etched appearance, then the ridges 28 deposited on the surface 16 should have a pattern 32 (FIG. 4). Additionally, edge 26 of the extraordinarily thick layer 24 (FIG. 1) may be formed with a pattern or texture 32 (FIG. 4) to give the appearance of etching.

In another step, the extraordinarily thick ridges 25 are deposited on surface 14 of substrate 12 in the desired design. As with the ridges 24, the ridges 25 may be deposited uniformly smoothly to create an embossed appearance or given a texture to create an etched appearance. Preferably, the ridges 25 are deposited in registration with the ridges 24 on the opposite side of the substrate 12. This may be accomplished using any conventional printing registration system.

A preferred method for depositing ink layer 22, ink ridges 24, ink ridges 25 or ink ridge 30 on substrate 12 is via silk screening; however, as noted above, any other printing methods, including conventional flexography, gravure, ultraviolet flexography and both web- and sheet-fed offset printing methods may be used. With the silk screen process, an extraordinarily thick layer ridge of ink may be deposited on substrate 12 using a mesh screen having approximately 60 lines per inch. The extraordinarily thick ridge or layer of ink is then subjected to ultraviolet radiation for approximately 1-20 seconds, more preferably 5-10 seconds and most preferably about 6 seconds, to cure the ink.

Preferably, the thin layer 22 of ink, rather than the extraordinarily thick layer of ink is disposed in the basic shape of the desired design before depositing the extraordinarily thick ink ridges 24 and 25 on substrate 12. The thin layer 22 of ink may be applied using the same silk screening technique indicated above; however, a mesh of about 300 lines per inch is preferably used. If ultra-violet light curable ink is used for the thin layer 22, that thin layer 22 may be subjected to ultraviolet light to cure it before ink ridges 24 are deposited at the edge of the design. This is done so the thin layer 22 cures adequately. Other techniques may be used to apply the layers of ink as desired, for example, the methods of silk-screening as set forth in U.S. Pat. No. 5,082,703 to Longobardi, issued Jan. 21, 1992, which is hereby incorporated by reference.

After the inks cure, or sufficiently dry out, depending on the type of ink used, sheet 28 as depicted in FIG. 2 is secured over the ink ridges 25, layer 22 and bottom surface 16. The sheet 28 may be rolled on or vacuum pressed over the substrate 14 to ensure that sheet 28 fills all crevices created on the surface 16 by the deposit of inks thereon. To facilitate this process, the substrate 12 and/or the sheet 28 may be heated.

III. First Alternative Embodiment

FIG. 6 shows a first alternative embodiment of the display of the present invention. In this embodiment, the entire ink layer 22 is extraordinarily thick. Thus, the design 18 in FIG. 1 appears uniformly raised. The extraordinarily thick ridges 25 on top surface 14 add a three-dimensional effect to the layer 22 of thick ink on the other side. Optionally, sheet 28 may be included. This sheet may be identical to that used in the preferred embodiment.

IV. Second Alternative Embodiment

With reference to FIG. 7, a second alternative embodiment of the present invention will now be described. The display 10 of FIG. 7 may be identical to the display of FIG. 2, with the exception that the ink ridges 25 on the top surface 16 of the substrate 14 are coated with a protective layer. This protective layer may be constructed of a varnish, a plastic, or any other commercially available transparent cover layer 27. Optionally, the protective layer 27 may be colored or tinted to add to the visual effect of the design on substrate 12. Preferably, this protective layer 27 is deposited onto the upper ridges 25 and upper surface 14 after the ink ridges 25 are cured or dried to prevent any smudging or moving of the ink ridges 25. As will be appreciated, the protective layer 27 may be used in any of the embodiments described herein to cover the ink ridges 25 deposited on the top surface 14 of the substrate 12.

IV. Third Alternative Embodiment

FIG. 8 depicts a third alternative embodiment which differs from the preferred embodiment of FIG. 2 in that a sheet 28 is not secured to the substrate 12. Rather, a stratum 34 is deposited onto surface 16, thin ink layer 22 and ink ridges 24 by commercially available processes such as by spraying a solution onto the surface 16, thin ink layer 22 and ink ridges 24 which solidifies to form stratum 34. The solution may include any appropriate reflective solution, for example a silver or gold-based or other metallic solution. Optionally, stratum 34 is deposited onto surface 16, thin ink layer 22 and ink ridges 24 by electroplating an appropriate dry reflective powder, for example aluminum-based powder, onto the surface 16, thin ink layer 22 and ink ridges 24. Although as depicted, the stratum 34 is deposited over surface 16, thin ink layer 22 and ink ridges 24, the stratum 34 may optionally cover only surface 16 as desired. This selective etching over the surface 16 or other portions on the substrate 12 may be performed in a variety of ways. For example, the stratum 34 may initially be deposited only onto surface 16. In another technique, stratum 34 is deposited onto surface 16, thin ink layer 22 and ink ridges 24 and then removed if desired from thin ink layer 22 and ink ridges 24 as desired.

Where stratum 34 is deposited over surface 16, thin ink layer 22, ink ridges 24 or any of these elements selectively, the stratum 34 may be covered with a protective layer 36 of paint or other coating material to minimize cracking and peeling of stratum 34. Additionally, a protective substrate 38 such as a copper foil, or sheet or plastic or paper coating may be disposed between the stratum 34 and paint layer 36.

The above descriptions are those of the preferred embodiments of the invention. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

The embodiments of the invention in which an exclusive property or privilege is claimed are defined as follows:

1. A graphic comprising:
a transparent substrate including first and second surfaces;
a layer of ink applied on said first surface to form a design including an edge;
a first extraordinarily thick ridge of ink applied on said first surface at said edge;
a second extraordinarily thick ridge of ink applied on said second surface in registration with said first extraordinarily thick ridge of ink; and
a cover layer deposited on said first surface to cover at least one of said design and said first extraordinarily thick ridge ink.

2. The graphic of claim 1 comprising at least one third extraordinarily thick ridge of ink applied on said first surface at a preselected distance from said first extraordinarily thick ridge of ink and in fixed registration with said second extraordinarily thick ridge of ink.

3. The graphic of claim 1 wherein said substrate is a transparent plastic.

4. The graphic of claim 1 wherein said first ridge of ink overlaps said edge of said design.

5. The graphic of claim 1 wherein said first ridge of ink is adjacent said edge of said design.

6. The graphic of claim 1 wherein at least one of said first extraordinarily thick ridge of ink and said second extraordinarily thick ridge of ink is textured.

7. The graphic of claim 1 wherein at least one of said layer of ink, said first extraordinarily thick ridge of ink and said second extraordinarily thick ridge of ink is curable with ultraviolet radiation.

8. The graphic of claim 1 wherein said cover layer is an adhesive sheet including a thin layer of transparent adhesive for adhering to said first surface.

9. The graphic of claim 1 wherein said stratum includes a solidified layer of metal-based liquid solution to adhere to said first surface.

10. The graphic of claim 1 wherein said stratum is a solidified stratum of a dry powder electroplated onto said first surface.

11. The graphic of claim 1 wherein said stratum is vacuum metallized onto said first surface.

12. The graphic of claim 1 wherein said stratum is reflective.

13. The graphic of claim 1 comprising a layer of paint deposited over said stratum opposite said first surface.

14. A display comprising:
a transparent substrate including a first side and a second side;
an image formed with at least one first extraordinarily thick ridge of ink deposited on said first side and at least one extraordinarily thick ridge of ink deposited on said second side.

15. The display of claim 14 comprising a thick layer of ink deposited on said first surface in a design, said first extraordinarily thick ridge of ink deposited along an edge of said design.

16. The display of claim 15 comprising a reflective layer conformable with said design and secured over said design and said first surface.

17. The display of claim 14 wherein at least one of said first and second extraordinarily thick ridges of ink is clear.

18. The display of claim 15 wherein said design has an edge and said edge appears to be embossed.

19. The display of claim 14 comprising protective layer disposed over said second extraordinarily thick ridge of ink.

20. A process for making a display comprising:
providing a transparent substrate;
depositing a thin ink layer on a first side of the substrate;
depositing a first extraordinarily thick ink ridge on the first side adjacent or on said thin ink layer; and
depositing a second extraordinarily thick ink ridge on said second side in registration with at least one from said first extraordinarily thick ink ridge and said thin ink layer.

21. The method of claim 17 comprising curing at least one of the first and second extraordinarily thick ink ridges and the thin ink layer with ultraviolet light.

22. The method of claim 19 comprising adhesively conforming a layer over the first surface of the substrate, the thin ink layer, and the first extraordinarily thick ink ridge.

23. The method of claim 19 comprising depositing a protective layer over said second extraordinarily thick ink ridge.

24. The method of claim 19 wherein at least one from said first extraordinarily thick ink ridge and said second extraordinarily thick ink ridge is clear.

25. A process for manufacturing a display including a transparent substrate having first and second sides comprising:
depositing at least one extraordinarily thick ink ridge on said first layer to outline an image;
depositing at least one second extraordinarily thick ink ridge on said second side of said display in registration with said image;
curing the first and second extraordinarily thick ink ridges; and
applying a reflective coating over the image and the first extraordinarily thick ink ridge.

26. The process of claim 25 comprising applying a protective coating over the second extraordinarily thick ink ridge.

27. The process of claim 25 wherein said reflective coating is a reflective ink deposited over the image.

28. The process of claim 27 comprising depositing a layer of paint over the reflective coating.
